(19) United States
(12) Patent Application Publication
(10) Pub. No.: US 2025/0331620 A1
(43) Pub. Date: Oct. 30, 2025

(54) AIR BLOWER AND VERTICAL HAIR DRYER

(71) Applicant: Shenzhen Senxuan Technology Co., Ltd., Shenzhen (CN)

(72) Inventors: Shilin LIANG, Shenzhen (CN); Shuquan Zheng, Shenzhen (CN); Zhaozhong Zeng, Shenzhen (CN); Shaoqiang Lin, Shenzhen (CN); Yunlong Dai, Shenzhen (CN); Xinfeng Song, Shenzhen (CN)

(21) Appl. No.: 18/989,026

(22) Filed: Dec. 20, 2024

(30) Foreign Application Priority Data
Apr. 29, 2024 (CN) 202410528333.5

(51) Int. Cl. A45D 20/12

(52) U.S. Cl. CPC A45D 20/12; A45D 2020/126

(57) ABSTRACT

An air blower and a vertical hair dryer are provided. The air blower includes a housing and a heating component. An air cavity, an air inlet area and an air outlet area are formed inside the housing, and the air inlet area and the air outlet area are in communication with the air cavity. The heating component is arranged in the air cavity, and the heating component separates the air cavity into a first sub-cavity and a second sub-cavity. The first sub-cavity is in communication with the air inlet area, and the second sub-cavity is in communication with the air outlet area. At least one of the heating component or the housing is provided with a ventilation area, and the ventilation area is in communication with the first sub-cavity and the second sub-cavity. The heating component is arranged in the first sub-cavity and the second sub-cavity.

### CROSS-REFERENCE TO RELATED APPLICATION

The application claims priority to Chinese Patent Application No. 202410528333.5, filed on Apr. 29, 2024, the disclosure of which is hereby incorporated by reference in its entirety.

### BACKGROUND

A hair dryer is a commonly used household appliance, and includes a heating component configured to heat air. The heating component is configured to heat the air to allow warm air to be generated, to dry hair or a laundry or the like efficiently. However, in an application scenario where long hair of a user or hair of a pet is dried, the hair dryer is in a working state for a long time. In the related art, the hair dryer has low heat dissipation efficiency, the air may not take away all heat of a surface of the heating component, and the heat may easily be accumulated in the hair dryer. This may lead to overheat of a surface of the hair dryer, and thus there is a risk that the user is scalded, which leads to a safety hazard. Moreover, after the heat is accumulated inside the hair dryer, the heating component has too high temperature, which may cause the heating component to be damaged or even overheated or destroyed. Therefore, the service life of the hair dryer is affected.

### SUMMARY

The disclosure relates to the technical field of household appliances, and more particularly to an air blower and a vertical hair dryer.

In view of the above, the disclosure provides an air blower and a vertical hair dryer to solve the technical problem of how to improve the heat dissipation efficiency of a heating component.

The technical solutions according to embodiments of the disclosure are implemented as follows.

An embodiment of the disclosure provides an air blower, which includes a housing and a heating component. An air cavity, an air inlet area and an air outlet area are formed inside the housing, and the air inlet area and the air outlet area are in communication with the air cavity. The air inlet area is configured to guide air into the air cavity, and the air outlet area is configured to discharge the air from the air cavity. The heating component is configured to heat the air. The heating component is arranged in the air cavity. The heating component separates the air cavity into a first sub-cavity and a second sub-cavity. The first sub-cavity is in communication with the air inlet area, and the second sub-cavity is in communication with the air outlet area. At least one of the heating component or the housing is provided with a ventilation area, and the ventilation area is in communication with the first sub-cavity and the second sub-cavity.

An embodiment of the disclosure provides a vertical hair dryer, which includes a support and a fan head. The fan head is connected to the support, and the fan head includes an air blower. The air blower includes a housing and a heating component. An air cavity, an air inlet area and an air outlet area are formed inside the housing, and the air inlet area and the air outlet area are in communication with the air cavity. The air inlet area is configured to guide air into the air cavity, and the air outlet area is configured to discharge the air from the air cavity. The heating component is configured to heat the air. The heating component is arranged in the air cavity. The heating component separates the air cavity into a first sub-cavity and a second sub-cavity. The first sub-cavity is in communication with the air inlet area, and the second sub-cavity is in communication with the air outlet area. At least one of the heating component or the housing is provided with a ventilation area, and the ventilation area is in communication with the first sub-cavity and the second sub-cavity.

### BRIEF DESCRIPTION OF THE DRAWINGS

FIG. 1 is a perspective schematic diagram of a vertical hair dryer according to an embodiment of the disclosure.

FIG. 2 is an exploded view of a fan head according to an embodiment of the disclosure.

FIG. 3 is an exploded view of an air blower according to an embodiment of the disclosure.

FIG. 4 is a bottom view of an air blower according to an embodiment of the disclosure.

FIG. 5 is a cross-sectional view taken along a direction A-A of FIG. 4.

FIG. 6 is a schematic diagram illustrating a flow of air in an air blower shown in FIG. 5.

FIG. 7 is a schematic diagram of a heating member wound along a third direction according to an embodiment of the disclosure.

FIG. 8 is a schematic diagram of a heating member wound along a first direction according to an embodiment of the disclosure.

FIG. 9 is a top view of an air blower according to an embodiment of the disclosure, in which a part of the air blower is omitted.

FIG. 10 is a cross-sectional view taken along a direction B-B of FIG. 4.

FIG. 11 is a front view of a fan head according to an embodiment of the disclosure.

FIG. 12 is a cross-sectional view taken along a direction C-C of FIG. 11.

### LIST OF REFERENCE SYMBOLS

101 fan head; 10 air blower; 11 housing; 111 air cavity; 1111 first sub-cavity; 1112

second sub-cavity; 112 air inlet area; 113 air outlet area; 114 ventilation area; 115 air inlet part; 1151 air inlet end; 1152 air outlet end; 116 air outlet; 1161 first air outlet; 1162 second air outlet; 117 upper housing; 118 lower housing; 12 heating component; 121 first mounting plate; 122 heating member; 123 second mounting plate; 13 fan; 14 fan cover; 20 shell; 21 mounting cavity; 22 outer air outlet; 23 ventilation mesh; 30 circuit board; 102 support.

### DETAILED DESCRIPTION

In order to make objectives, technical solutions and advantages of the disclosure more clear, the disclosure will be further described in detail below in combination with the drawings and the embodiments. It should be understood that the specific embodiments described herein are only intended to explain the disclosure and are not intended to limit the disclosure

The individual specific technical features described in the specific embodiments may be combined with each other in any suitable manner without conflict. For example, different embodiments and technical solutions may be formed by the combination of different specific technical features. In order to avoid unnecessary repetition, the various possible combinations of the individual specific technical features of the disclosure are not described separately.

In the following description, the terms “first\second\ . . . ” are used only to distinguish different objects from each other, and do not indicate that there are similarities or connections between the objects. It should be understood that the orientation descriptions “above”, “below”, “outside” and “inside” are orientations in a normal use state, and the “left” and “right” directions refer to the left and right directions indicated in the specific corresponding schematic diagrams, and may or may not be the left and right directions in the normal use state.

It should be noted that the terms “including”, “include” or any other variation thereof are intended to encompass non-exclusive inclusion, so that a process, a method, an object or a device that includes a set of elements includes not only those elements but also other elements that are not explicitly listed, or also includes elements inherent to such the process, the method, the object or the device. In the absence of further limitations, an element defined by the phrase “includes a . . . ” does not preclude the existence of another identical element in the process, the method, the object or the device that includes the element. The expression “a plurality of” represents more than or equal to two.

A hair dryer includes a fan head configured to discharge air. A grip hair dryer further includes a grip handle, which is connected to the fan head and which provides a location where the user applies force. A vertical hair dryer also includes a support connected to the fan head, and the support is supported on the ground to allow two hands of the user to be freed. An embodiment of the disclosure provides an air blower 10, which may be provided separately as the “fan head” described above and directly connected to the grip handle or the support, or may be provided as an internal component arranged in the fan head. It should be noted that the air blower 10 may be applied to the vertical hair dryer or the grip hair dryer. A type of an application scenario of the embodiment of the disclosure is not intended to limit the structure of the air blower 10 according to the embodiment of the disclosure.

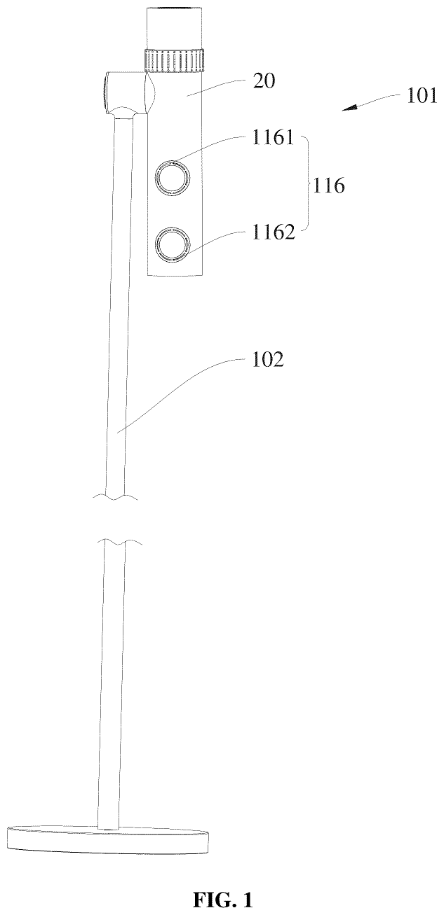

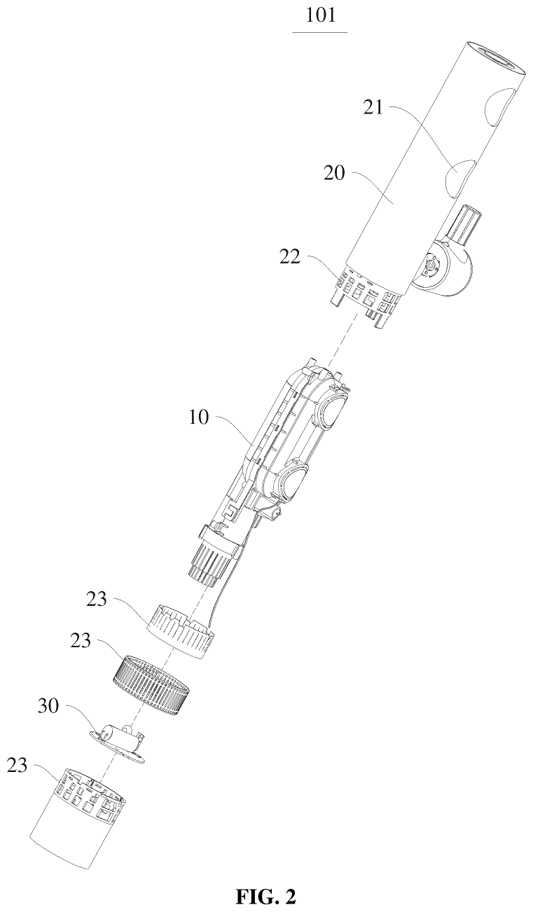

For convenience of explanation, as shown in FIG. 1 and FIG. 2, as an example, the air blower 10 is applied to the vertical hair dryer, and the air blower 10 serves as an internal component arranged in the fan head 101.

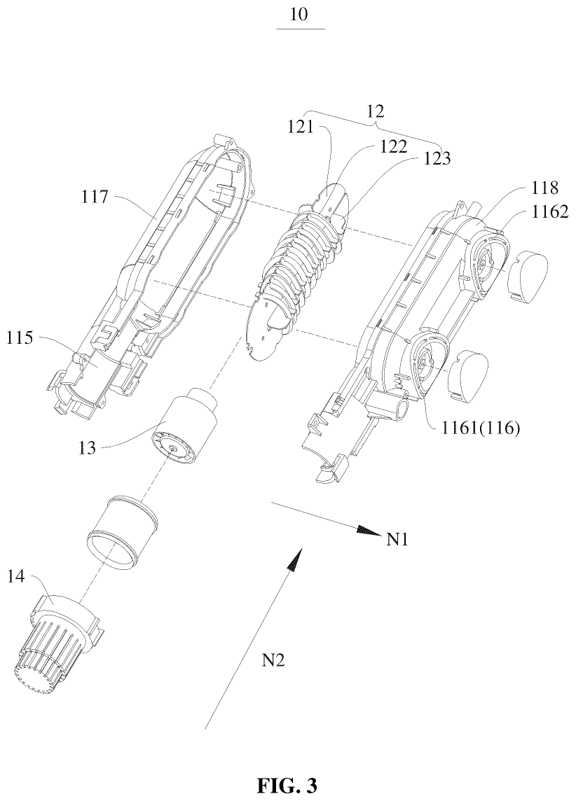

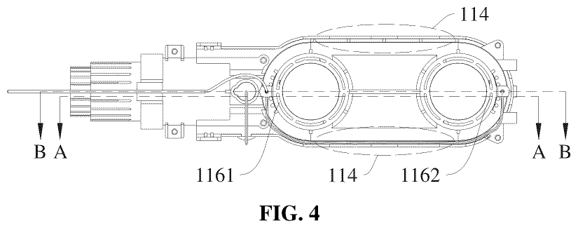

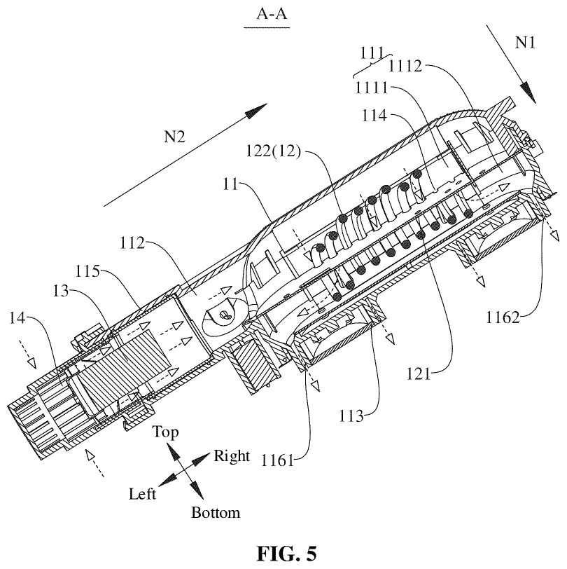

With reference to FIG. 3, the air blower 10 includes a housing 11 and a heating component 12. The housing 11 is hollow, and the heating component 12 is arranged in the housing 11. With reference to FIG. 4 and FIG. 5, an air cavity 111, an air inlet area 112 and an air outlet area 113 are formed inside the housing 11, and the air inlet area 112 and the air outlet area 113 are in communication with the air cavity 111. The air inlet area 112 is configured to guide the air into the air cavity 111, and the air outlet area 113 is configured to discharge the air from the air cavity 111. The heating component 12 is configured to heat the air. The heating component 12 is arranged in the air cavity 111, and the heating component 12 separates the air cavity 111 into a first sub-cavity 1111 and a second sub-cavity 1112. The first sub-cavity 1111 is in communication with the air inlet area 112, and the second sub-cavity 1112 is in communication with the air outlet area 113. At least one of the heating component 12 or the housing 11 is provided with a ventilation area 114, and the ventilation area 114 is in communication with the first sub-cavity 1111 and the second sub-cavity 1112. The heating component 12 is arranged in the first sub-cavity 1111 and the second sub-cavity 1112. In this way, the air does not directly enter the air outlet area 113 from the air inlet area 112. After the air enters from the air inlet area 112, the air firstly passes through the first sub-cavity 1111, then enters the second sub-cavity 1112 through the ventilation area 114, and finally is discharged through the air outlet area 113. The heat of a surface of the heating component 12 may be taken away at least twice by the flow of the air in the first sub-cavity 1111 and the second sub-cavity 1112, to facilitate the heat dissipation of the heating component 12 to allow the heating component 12 to sufficiently heat the air. In this way, the heat accumulation of the surface of the heating component 12 is reduced, and the risk that the heating component 12 is damaged due to too high temperature of the heating component 12 is reduced.

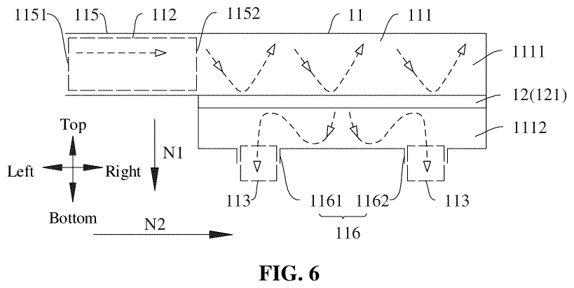

Specifically, for convenience of explanation, a part of the heating component 12 in the first sub-cavity 1111 is defined as an upper part of the heating component 12, and a part of the heating component 12 in the second sub-cavity 1112 is defined as a lower part of the heating component 12. With reference to a schematic diagram illustrating the flow of the air in FIG. 5 and FIG. 6, the second sub-cavity 1112 is separated from the air inlet area 112. The air entering from the air inlet area 112 firstly passes through the first sub-cavity 1111, and then reaches the second sub-cavity 1112. However, the air entering the first sub-cavity 1111 may not directly enter the second sub-cavity 1112 due to the “blocking” of a surface of an inner wall of the housing 11 and the heating component 12, but may be guided toward the second sub-cavity 1112 through the ventilation area 114. The air is blocked in a plurality of positions in the first sub-cavity 1111 to form circulating turbulence, and the air forming the turbulent may take away the heat of the upper part of the heating component 12 at least once. Similarly, the air entering the second sub-cavity 1112 through the ventilation area 114 also forms circulating turbulence due to the “blocking” of a surface of an inner wall of the housing 11 and the heating component 12, and may take away the heat of the lower part of the heating component 12 at least once. The heating component 12 exchanges the heat with the air at least twice, to allow the heating component 12 to sufficiently heat the air. In this way, the heat dissipation efficiency of the heating component 12 is improved, and the service life of the hair dryer is prolonged.

It should be noted that with reference to FIG. 6, the air cavity 111 only represents a part of a cavity inside the housing 11 adjacent to the heating component 12, and does not represent the entire cavity inside the housing 11. It can be simply understood that a part of the cavity above the heating component 12 is the first sub-cavity 1111, and a part of the cavity below the heating component 12 is the second sub-cavity 1112. Each of the “air inlet area 112”, the “air outlet area 113” and the “ventilation area 114” described above represents a virtual space. Taking the air inlet area 112 as an example, when the housing 11 is provided with an opening in direct communication with the air cavity 111 and configured to allow the entrance of the air, a space formed by the opening represents the air inlet area 112. When a plurality of openings are provided, an area obtained by the sum of spaces formed by the plurality of openings represents the air inlet area 112. When the opening extends to form a channel, a space in the channel represents the air inlet area 112.

Specifically, the expression “at least one of the heating component 12 or the housing 11 is provided with the ventilation area 114” described above means that the ventilation area 114 may be arranged on the heating component 12, or may be arranged on the inner wall of the housing 11, or may be arranged on the heating component 12 and the housing 11, or may also be arranged between the heating component 12 and the housing 11. The disclosure is not intended to limit the specific position of the ventilation area 114, as long as the air in the first sub-cavity 1111 may enter the second sub-cavity 1112 through the ventilation area 114.

The air blower 10 according to the embodiment of the disclosure includes the housing 11 and the heating component 12. The air cavity 111, the air inlet area 112 and the air outlet area 113 are formed inside the housing 11, and the air inlet area 112 and the air outlet area 113 are in communication with the air cavity 111. The air inlet area 112 is configured to guide the air into the air cavity 111, and the air outlet area 113 is configured to discharge the air from the air cavity 111. The heating component 12 is configured to heat the air. The heating component 12 is arranged in the air cavity 111, and the heating component 12 separates the air cavity 111 into the first sub-cavity 1111 and the second sub-cavity 1112. The first sub-cavity 1111 is in communication with the air inlet area 112, and the second sub-cavity 1112 is in communication with the air outlet area 113. At least one of the heating component 12 or the housing 11 is provided with the ventilation area 114, and the ventilation area 114 is in communication with the first sub-cavity 1111 and the second sub-cavity 1112. In this way, the heating component 12 is arranged in the first sub-cavity and the second sub-cavity. The air enters the first sub-cavity 1111 from the air inlet area 112, then reaches the second sub-cavity 1112 through the ventilation area 114, and finally is discharged through the air outlet area 113. Due to the blocking of the surface of the inner wall of the housing 11 and the heating component, the air forms the circulating turbulent in the first sub-cavity 1111 and the second sub-cavity 1112 to take away the heat of the upper part of the heating component 12 and the heat of the lower part of the heating component 12. The heating component 12 exchanges the heat with the air at least twice, to allow the heating component 12 to sufficiently heat the air. In this way, the drying efficiency of a laundry or hair or hair of a pet is improved, and the heat accumulation of the surface of the heating component 12 is reduced. Therefore, the heat dissipation efficiency of the heating component 12 is improved, the risk that the heating component 12 is damaged due to too high temperature of the heating component 12 is reduced, and the service life of the hair dryer is prolonged.

In some embodiments, with reference to FIG. 5, a volume of the first sub-cavity 1111 is greater than a volume of the second sub-cavity 1112, to allow hot air and cold air to be evenly mixed by the second sub-cavity 1112 with a smaller volume. As can be seen from the above, since the air in the first sub-cavity 1111 flows toward the second sub-cavity 1112, the second sub-cavity 1112 is located downstream of the first sub-cavity 1111. In addition, the second sub-cavity 1112 has the smaller volume. Therefore, according to the phenomenon of “local high pressure area” of the fluid mechanics, the fluid accumulates according to a path with a slower flow speed in a flow process, that is, the air firstly accumulates in the first sub-cavity 1111 located upstream. The air located at an inlet of the first sub-cavity 1111 (i.e., the air guided from the air inlet area 112) may be regarded as the “cold air”, and the air is heated by a part of the heating component 12 arranged in the first sub-cavity 1111 to form the “hot air”. The first sub-cavity 1111 has a larger volume, and there is sufficient time and space to allow the hot air to be evenly mixed with the cold air. In addition, the turbulence effect and the convection effect in the first sub-cavity 1111 with the larger volume also help to accelerate the mixing of the hot air and the cold air. The cavity with a smaller volume has a smaller cross-sectional area. According to Bernoulli equation, for a certain amount of air, under the condition that the pressure, the temperature and the molar coefficient remain unchanged, the air flows at a larger speed in a position where the cavity has a smaller cross-sectional area, and the air flows rapidly to allow the air to be discharged from the air outlet area 113.

Specifically, the volume of the first sub-cavity 1111 may be greater than the volume of the second sub-cavity 1112 by changing at least one of a position of the heating component 12 or a shape of a local contour of the housing 11. In some embodiments shown in the schematic diagram of the disclosure, an outer contour of the housing 11 is symmetrical from top to bottom, the heating component 12 is located below a symmetrical plane of the housing 11, and a shape of the first sub-cavity 1111 is substantially the same as a shape of the second sub-cavity 1112. In this way, the volume of the first sub-cavity 1111 is greater than the volume of the second sub-cavity 1112, that is, a cross-sectional area of the first sub-cavity 1111 is greater than a cross-sectional area of the second sub-cavity 1112, in which a cross-sectional direction is a direction perpendicular to the heating component 12 and extending from the first sub-cavity 1111 to the second sub-cavity 1112 (i.e., a left-right and front-rear direction from a viewing angle of FIG. 5). According to the Bernoulli principle, the cross-sectional area is smaller, the pressure is smaller, and the flow speed of the air is larger. Therefore, the flow speed of the air in the second sub-cavity 1112 is greater than the flow speed of the air in the first sub-cavity 1111. The cold air accumulates in the first sub-cavity 1111 to allow the heating component 12 to be in contact with the cold air, to realize the heating of the cold air. The air in the second sub-cavity 1112 flows at a larger speed to allow the heat in the air cavity 111 to be more easily taken away through the air outlet area 113, to reduce the heat accumulation of the heating component 12.

In some embodiments, with reference to FIG. 5 and FIG. 6, the air outlet area 113 is arranged at an end of the heating component 12 in a first direction N1, and the air inlet area 112 is arranged at an end of the heating component 12 in a second direction N2, in which the first direction N1 is perpendicular to the second direction N2. The air entering from the air inlet area 112 is guided toward the first sub-cavity 1111 along the second direction N2, and then is guided toward the second sub-cavity 1112 along the first direction N1. The air inlet area 112 and the air outlet area 113 are not located on a same straight line, and the air in the air inlet area 112 does not directly pass through the ventilation area 114 along a straight line, but is guided from the air inlet area 112 toward the air outlet area 113 in a substantially “L” shape. Due to the limitation of a transfer path, a flow rate of the air entering the first sub-cavity 1111 is greater than a flow rate of the air discharged from the first sub-cavity 1111, that is, the air “firstly accumulates in the first sub-cavity 1111 and then is discharged from the first sub-cavity 1111”. On the one hand, the air stays in the first sub-cavity 1111 for a long time, to allow the heating component 12 to be in sufficient contact with the air in the first sub-cavity 1111, to improve the heating efficiency of the air in the first sub-cavity 1111. On the other hand, according to the turbulence effect and the airflow cutting effect, a speed of the airflow in a form of a straight line is greater, and is quite different from a speed of the static air around the airflow. In this way, it is easy to form a greater speed gradient, which drives air molecules to generate additional collisions and vortices and which in turn generates a large noise. An air duct (an area from the air inlet area 112 to the air outlet area 113) in the air blower 10 according to the embodiment of the disclosure is provided as the substantially “L” shape, to allow the air to be guided from the air inlet area 112 toward the air outlet area 113 in the substantially “L” shape. The air does not flow along the straight line, which may reduce the noise in the air blower 10.

It should be noted that the “first direction N1” described above is a direction (an top-bottom direction) indicated by an arrow denoted by N1 in FIG. 6, and the air outlet area 113 is located at a lower end of the first direction N1. The “second direction N2” described above is a direction (a left-right direction) indicated by an arrow denoted by N2 in FIG. 6, and the air inlet area 112 is located at a left end of the second direction N2. The air in the air cavity 111 is firstly guided into the first sub-cavity 1111 substantially along a direction from left to right, and then the air in the air cavity 111 is guided into the second sub-cavity 1112 and discharged from the second sub-cavity 1112 substantially along a direction from top to bottom.

In some embodiments, with reference to FIG. 3, the heating component 12 includes a first mounting plate 121 and a heating member 122. The first mounting plate 121 is arranged in the housing 11 and extends along the second direction N2. The first mounting plate 121 is arranged in the housing 11 and separates the air cavity 111 into the first sub-cavity 1111 and the second sub-cavity 1112. From a viewing angle of FIG. 5 and FIG. 6, a part of the cavity above the first mounting plate 121 is the first sub-cavity 1111, and a part of the cavity below the first mounting plate 121 is the second sub-cavity 1112. At least one of the first mounting plate 121 or the housing 11 is provided with a ventilation structure forming the ventilation area 114, and the air in the first sub-cavity 1111 enters the second sub-cavity 1112 through the ventilation structure.

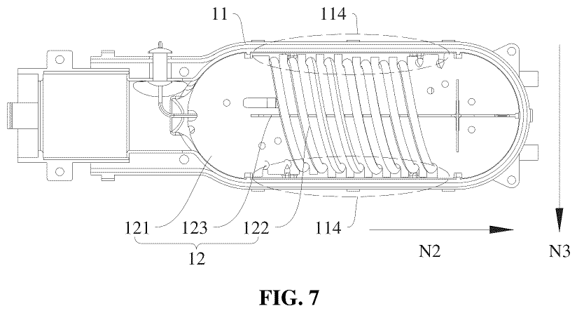

Specifically, the ventilation structure may be a hole or groove structure arranged on the first mounting plate 121, or may be a hole or groove structure arranged on the inner wall of the housing 11, or may be a hole or groove structure arranged on a surface of the inner wall of the housing 11 and the first mounting plate 121, or may also be a gap arranged between the first mounting plate 121 and the housing 11. Certainly, the embodiments described above do not necessarily exist independently of each other, and multiple types of ventilation structures may exist simultaneously. As shown in FIG. 7, a part (an upper housing 117) of the housing 11 that obscures the first mounting plate 121 is omitted. In some embodiments shown in FIG. 7, the first mounting plate 121 is provided with a plurality of through holes, and the plurality of through holes are spaced apart from each other along the second direction N2. Moreover, there is a gap between the inner wall of the housing 11 and the first mounting plate 121, and the plurality of through holes and the gap between the inner wall of the housing 11 and the first mounting plate 121 form the ventilation area 114 (a position enclosed by an ellipse indicated by a dashed line). In addition, the first mounting plate 121 is spaced apart from the housing 11, which may reduce the risk that the user is scalded since the heat of the heating member 122 is directly transferred to the housing 11 under the action of heat conduction.

As shown in FIG. 3 and FIG. 5, the heating member 122 is configured to heat the air, the heating member 122 is arranged on the first mounting plate 121, and the heating member 122 is arranged in at least one of the first sub-cavity 1111 or the second sub-cavity 1112. In this way, the first mounting plate 121 forms a structure which separates the first sub-cavity 1111 from the second sub-cavity 1112, and the heating member 122 only serves a “heating” structure. In the processing and assembly stage, since the processing difficulty of the first mounting plate 121 is less than the processing difficulty of the heating member 122, the first mounting plate 121 may be customized. In this way, the first mounting plate 121 may be adapted to a shape of the surface of the inner wall of the housing 11 and may separate the first sub-cavity 1111 from the second sub-cavity 1112, and the first mounting plate 121 may be configured to mount the heating member 122, which may facilitate the processing and assembly of the air blower 10. Moreover, the first mounting plate 121 has a more regular shape than the heating member 122, which may facilitate the fixation and assembly of the first mounting plate 121 through a connection structure arranged in the housing 11, and in turn may realize the modular assembly of the heating component 12.

Specifically, in some embodiments, the heating member 122 may be provided as a separate zero device (such as an electromagnetic heating piece or an electromagnetic pole piece) and may be arranged in the first sub-cavity 1111 or the second sub-cavity 1112. Or, the heating member 122 may also be arranged in the first sub-cavity 1111 and the second sub-cavity 1112. Certainly, the heating component 12 may also be provided with a plurality of heating members 122. Each of the plurality of heating members 122 may be arranged in the first sub-cavity 1111 or the second sub-cavity 1112, or may also be arranged in the first sub-cavity 1111 and the second sub-cavity 1112. The disclosure is not intended to limit the specific position and the number of the plurality of heating members 122, as long as there is at least one heating member 122 in any sub-cavity and the at least one heating member 122 is connected to the first mounting plate 121.

It should be noted that even if the heating member 122 is only arranged in one sub-cavity, the effect that “the heat of the surface of the heating component 12 may be taken away at least twice by the circulating turbulence of the air in the first sub-cavity 1111 and the second sub-cavity 1112” may be realized. The heat of the heating member 122 is inevitably conducted to the first mounting plate 121 under the action of the flow of the air, and the first mounting plate 121 which separates the first sub-cavity 1111 from the second sub-cavity 1112 is arranged in two sub-cavities. In this way, the circulating turbulence of the air in the first sub-cavity 1111 and the second sub-cavity 1112 may be in contact with the first mounting plate 121, to take away the heat of a surface of the first mounting plate 121, which may still be regarded as the fact that “the heat of the surface of the heating component 12 may be taken away”.

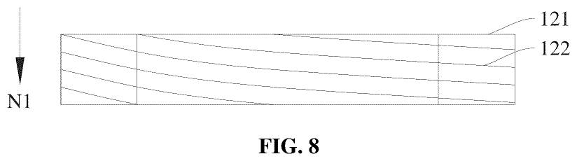

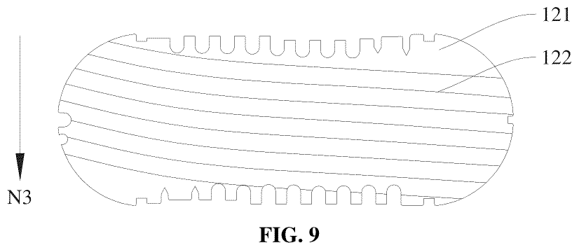

In some embodiments, with reference to FIG. 7 to FIG. 9, in FIG. 7 and FIG. 9, the first mounting plate 121 is viewed from a top view, and in FIG. 8, the first mounting plate 121 is viewed from a front view. A winding direction of the heating member 122 is a direction in which a central axis of the heating member 122 is located. Specifically, the heating member 122 may wind around the first mounting plate 121 along the first direction N1 (FIG. 8), or the heating member 122 may wind around the first mounting plate 121 along the second direction N2 (FIG. 7), or the heating member 122 may wind around the first mounting plate 121 along a third direction N3 (FIG. 9). Regardless of the direction along which the heating member 122 winds around the first mounting plate 121, the heating member 122 is provided as a flexible structure (such as a resistance wire or an electric heating tube). That is, the heating member 122 has elasticity to allow the heating member 122 to wind around the first mounting plate 121. Compared with other electromagnetic heating member 122, the heating member 122 made of the resistance wire or the electric heating tube has a lower cost, which may reduce the manufacturing cost of the heating component 12. In some embodiments shown in the schematic diagram of the disclosure, the heating member 122 is provided as the resistance wire, and the resistance wire has greater elasticity than the electric heating tube and is easily deformed to realize the connection with the first mounting plate 121.

In some possible embodiments, the heating member 122 winds around the first mounting plate 121. That is, the heating member 122 may be provided as a separate zero device and may be arranged in the first sub-cavity 1111 and the second sub-cavity 1112. That is, one part of the heating member 122 is arranged in the first sub-cavity 1111, and another part of the heating member 122 is arranged in the second sub-cavity 1112. The heating member 122 is arranged in the two sub-cavities, which may reduce the assembly cost of the heating component 12, and may allow the heat of a surface of the heating member 122 to be taken away at least twice by the circulating turbulence of the air in the first sub-cavity 1111 and the second sub-cavity 1112. In this way, the heat dissipation efficiency is higher, the heat exchange between the heating member 122 and the air is promoted, and the heat accumulation of the surface of the heating member 122 is reduced.

With reference to FIG. 3 and FIG. 7, in order to facilitate the description of the arrangement of the heating member 122 shown in the schematic diagram of the disclosure, as an example, the heating member 122 is provided as a resistance wire, and the heating member 122 winds around the first mounting plate 121 along the second direction N2. In this way, the heating member 122 is stacked in layers along the second direction N2, and a stacking direction of the heating member 122 is in consistent with an air inlet direction of the first sub-cavity 1111. In the process that the air enters the first sub-cavity 1111 along the second direction N2, the air passes through each of the layers of the resistance wire sequentially, and each of the layers of the resistance wire may be in contact with an inlet air in the first sub-cavity 1111, which may improve the heat exchange efficiency of an outer peripheral surface of the resistance wire. With reference to FIG. 5, the air in the first sub-cavity 1111 is guided into the second sub-cavity 1112 along the first direction N1, in which the first direction N1 is perpendicular to the second direction N2, and then an air outlet direction of the first sub-cavity 1111 is perpendicular to the stacking direction of the heating member 122. The air from the first sub-cavity 1111 to the second sub-cavity 1112 is blown to the second sub-cavity 1112 along a direction perpendicular to the stacking direction of the resistance wire. That is, an outlet air in the first sub-cavity 1111 may pass between every two adjacent layers of the layers of the resistance wire to perform the secondary heat dissipation of the heating member 122. The outlet air in the first sub-cavity 1111 takes away the heat between the every two adjacent layers of the layers of the heating member 122. The inlet air cooperates with the outlet air, the inlet air passes through the surface of the resistance wire along the second direction N2, and the outlet air passes through a spacing between the every two adjacent layers of the layers of the resistance wire along the first direction N1. The inlet air and the outlet air take away the heat of the surface of the heating member 122 in stages, which may reduce the heat accumulation of the heating member 122 located in the first sub-cavity 1111. Moreover, the heating member 122 is provided as the separate zero device, and there is the heat conduction among multiple parts of the heating member 122. After the temperature of the heating member 122 (an upper heating member 122) located in the first sub-cavity 1111 decreases, the heat of the heating member 122 (a lower heating member 122) located in the second sub-cavity 1112 is transferred to the upper heating member 122 under the action of the heat conduction, which may also facilitate the heat dissipation of the heating member 122 located in the second sub-cavity 1112.

In some embodiments, with reference to FIG. 7, a winding location where the heating member 122 winds around the first mounting plate 121 is arranged in the ventilation area 114, the winding location is provided as a location where the heating member 122 is in contact with the first mounting plate 121, and the heat is easily accumulated at the winding location. The heating member 122 winds around the first mounting plate 121 in the ventilation area 114, and the heat of the winding location may be taken away by the flow of the air in the ventilation area 114, which may reduce the heat accumulation of the location where the first mounting plate 121 is in contact with the heating member 122. Specifically, the first mounting plate 121 is provided with a plurality of through holes, and each of the layers of the resistance wire is snapped into a respective one of the plurality of through holes. On the one hand, there is a spacing between the every two adjacent layers of the layers of the resistance wire, which may reduce the heat transfer between the every two adjacent layers of the layers of the resistance wire. On the other hand, the heat of each of the layers of the resistance wire may be taken away by the flow of the air in each of the plurality of through holes, which may improve the heat dissipation efficiency of the resistance wire (the heating member 122), and which may reduce the risk that the resistance wire (the heating member 122) is overheated or even destroyed due to too high temperature of the resistance wire (the heating member 122).

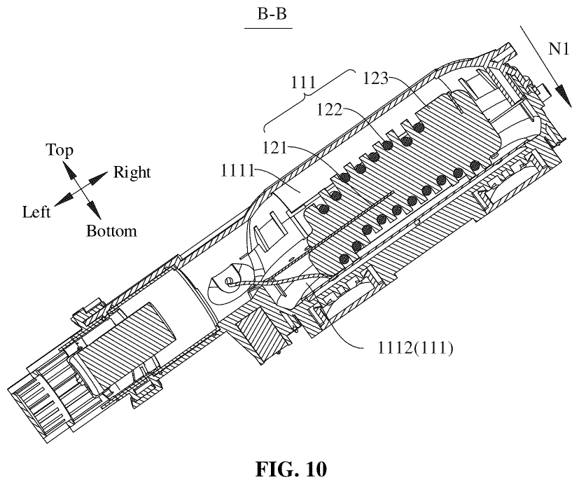

In some embodiments, with reference to FIG. 3 and FIG. 10, a volume of the heating member 122 located in the first sub-cavity 1111 is greater than a volume of the heating member 122 located in the second sub-cavity 1112. That is, a volume of the upper heating member 122 is greater than a volume of the lower heating member 122. As can be seen from the above, the air inlet direction of the first sub-cavity 1111 is perpendicular to the air outlet direction of the first sub-cavity 1111, and the heat of the upper heating member 122 may be taken away twice by the inlet air and the outlet air. Because of the limitation of the ventilation area 114, the air firstly accumulates in the first sub-cavity 1111 and then is discharged from the first sub-cavity 1111, and the air in the first sub-cavity 1111 has a greater density. The heating member 122 with a greater volume is arranged in the first sub-cavity 1111, to allow the heating member 122 to be in sufficient contact with the air with the greater density in the first sub-cavity 1111. In this way, the heating efficiency of the air may be improved, and the heat transfer of the upper heating member 122 may be promoted by the air flowing in multiple directions.

Specifically, in some possible embodiments, the volume of the upper heating member 122 may be greater than the volume of the lower heating member 122 by changing a shape of the first mounting plate 121. For example, the first mounting plate 121 is provided as a barrel structure, and a middle plane of the first mounting plate 121 is located in the first sub-cavity 1111. In this way, the volume of the heating member 122 located on the upper part of the first mounting plate 121 is greater than the volume of the heating member 122 located on the lower part of the first mounting plate 121.

In some embodiments, with reference to FIG. 3 and FIG. 10, the heating component 12 further includes a second mounting plate 123, and the second mounting plate 123 is connected to the first mounting plate 121 and abuts against the heating member 122 along the first direction N1. Specifically, a plurality of second mounting plates 123 may be arranged on the first mounting plate 121, and the plurality of second mounting plates 123 are perpendicular to each other and are arranged on the first mounting plate 121. A surface of an outer wall of each of the plurality of second mounting plates 123 and a surface of an outer wall of the first mounting plate 121 jointly form a location for supporting the heating member 122. In some embodiments shown in the schematic diagram of the disclosure, only one second mounting plate 123 is provided, and the second mounting plate 123 is perpendicular to the first mounting plate 121. That is, the second mounting plate 123 and the first mounting plate 121 are provided in a form of a cross snapped structure. On the one hand, the second mounting plate 123 may improve the mounting stability of the heating member 122. On the other hand, the volume of the heating member 122 located in the first sub-cavity 1111 may be greater than the volume of the heating member 122 located in the second sub-cavity 1112 by changing a position or shape of the second mounting plate 123. For example, a symmetrical middle plane of the second mounting plate 123 is directly located in the first sub-cavity 1111, or the second mounting plate 123 is arranged in the first sub-cavity 1111. As such, the heating member 122 supported on the second mounting plate 123 generates a volume difference. Compared with the change of the shape of the first mounting plate 121, it is easier to realize the change of the position of the second mounting plate 123. The second mounting plate 123 only abuts against an inner ring of the heating member 122 and is not in contact with an outer ring of the heating member 122. An enclosed barrel space is present on an inner side of the heating member 122 arranged in a winding form still, and the air may flow in the barrel space to take away the heat of the inner side of the heating member 122. Moreover, the heating member 122 abutted by the second mounting plate 123 is expanded along the first direction N1, which leads to an elastic expansion of the resistance wire and an increase of the pitch of a single resistance wire. In this way, the heat transfer of the heating member 122 is realized.

In some embodiments, with reference to FIG. 3 and FIG. 6, the housing 11 is provided with an air inlet part 115, and the air inlet part 115 is hollow. The air inlet part 115 is provided with an air inlet end 1151 and an air outlet end 1152, the air inlet area 112 is formed between the air inlet end 1151 and the air outlet end 1152, and the air outlet end 1152 is connected to the air cavity 111. That is, the air inlet part 115 is a channel-shaped member with a certain length, and the air inlet area 112 represents a channel space in the air inlet part 115. With reference to FIG. 5, the air blower 10 further includes a fan 13 configured to form a negative pressure to drive the air to flow, and the fan 13 is arranged between the air inlet end 1151 and the air outlet end 1152. The air passing through the fan 13 is accelerated to flow toward the first sub-cavity 1111 due to the influence of a blade of the fan 13. On the one hand, the fan 13 is not arranged in the air cavity 111 and is not easily affected by the hot air in the air cavity 111. In this way, the fan 13 is not easy to work in a high-temperature environment, which may prolong the service life of the fan 13. On the other hand, the fan 13 is arranged between the air outlet end 1152 and the air inlet end 1151 and is located in the air inlet area 112 inside the housing 11. In this way, the fan 13 is arranged adjacent to the first sub-cavity 1111, which may facilitate the concentration of the air quantity in the first sub-cavity 1111.

In some embodiments, with reference to FIG. 5, the housing 11 is provided with a plurality of air outlets 116 on a side of the housing 11, and an opening space of each of the plurality of air outlets 116 jointly forms the air outlet area 113 described above. That is, each of the plurality of air outlets 116 is in communication with the second sub-cavity 1112. A cross-sectional area of the plurality of air outlets 116 is less than a cross-sectional area of the second sub-cavity 1112. As such, a pressure at the plurality of air outlets 116 is less than a pressure in the second sub-cavity 1112 according to the Bernoulli equation. In this way, the air in the second sub-cavity 1112 is automatically guided toward the plurality of air outlets 116 under the action of the pressure difference. The plurality of air outlets 116 are arranged on a same side of the housing 11 and are located downstream of the second sub-cavity 1112. The air is centrally guided toward the plurality of air outlets 116 by the second sub-cavity 1112, to be automatically separated from each other. There is no sequential order in the flow of the air between the plurality of air outlets 116, and the plurality of air outlets 116 are located on the same side of the housing 11 and have approximately equal static pressure. The air quantity guided by the second sub-cavity 1112 toward each of the plurality of air outlets 116 is approximately equal, and the air is evenly discharged from the plurality of air outlets 116. It is not necessary to arrange an air guide blade between every two air outlets of the plurality of air outlets 116, and it is not necessary to arrange an air guide duct in communication with each of the plurality of air outlets 116, which may shorten a distance between the every two air outlets of the plurality of air outlets 116. Moreover, there is no need to reserve a space for mounting an air separation structure such as an air guide blade or an air guide duct in the air cavity 111, which may reduce a volume of the air blower 10.

In addition, an air inlet direction of the second sub-cavity 1112 is in consistent with the air outlet direction of the first sub-cavity 1111, and the air flows from top to bottom along the first direction N1. The air outlet area 113 is located at an end of the second sub-cavity 1112 in the first direction N1, and an air outlet direction of the second sub-cavity 1112 is also a direction from top to bottom. The air inlet direction of the second sub-cavity 1112 is in consistent with the air outlet direction of the second sub-cavity 1112, and the plurality of air outlets 116 are located downstream of the second sub-cavity 1112. The air is preferentially directly separated from each other in a direction of the flow of the air in the second sub-cavity 1112 by the influence of the pressure difference between the plurality of air outlets 116, and the air is not easily indirectly separated from each other due to the blocking and collision of the inner wall of the housing 11. The number of separation times of the air in the second sub-cavity 1112 is related to the number of the plurality of air outlets 116. In this way, the plurality of air outlets 116 have approximately equal air quantity, which may improve the user experience.

With reference to FIG. 1, in a case where the air blower 10 is applied to the vertical hair dryer, an application scenario where the long hair is pre-dried by the vertical hair dryer is taken as an example. In the vertical hair dryer, the hair located at a rear of a head may be dried by a first air outlet 1161, and the hair located at a top of the head may be dried by a second air outlet 1162. The hair located at different locations of the head of the user may be dried by the plurality of air outlets 116, which may improve the drying efficiency of the hair and improve the user experience.

In some embodiments, with reference to FIG. 4 and FIG. 5, the plurality of air outlets 116 include a first air outlet 1161 and a second air outlet 1162, and a position enclosed by an ellipse shown in FIG. 4 is a position where the ventilation area 114 is located. As can be seen from FIG. 4, at least a part of the ventilation area 114 is arranged between the first air outlet 1161 and the second air outlet 1162. The air entering the second sub-cavity 1112 from the ventilation area 114 is not directly discharged from the second sub-cavity 1112 through the air outlet 116, but is separated from each other at a middle part of the second sub-cavity 1112 to be guided toward the first air outlet 1161 and the second air outlet 1162. The air “firstly accumulates in the second sub-cavity 1112 and then is discharged from second sub-cavity 1112”. The position of the ventilation area 114 is arranged to allow each of the two air outlets to be approximately equidistant from the ventilation area 114. In this way, the two air outlets have equal static pressure, to allow the air entering the second sub-cavity 1112 from the ventilation area 114 to be evenly separated from each other. With reference to the schematic diagram of the flow of the air shown in FIG. 5, the air entering the second sub-cavity 1112 from the ventilation area 114 is evenly separated from each other at the middle part of the second sub-cavity 1112. A part of the air flows into the first air outlet 1161 toward the left, and another part of the air flows into the second air outlet 1162 toward the right. In this way, the first air outlet 1161 and the second air outlet 1162 have uniform air quantity, and it is not easy to generate a greater air quantity difference.

In addition, since the air outlet area 113 is arranged at an end of the heating component 12 in the first direction N1, the plurality of air outlets 116 are located at an end of the heating component 12 in the first direction N1. As can be seen from the above, the air is guided into the second sub-cavity 1112 and is discharged from the second sub-cavity 1112 along the first direction N1. A direction of the flow of the air on an upstream side of the second sub-cavity 1112 is in consistent with a direction of the flow of the air on a downstream side of the second sub-cavity 1112. The air is preferentially directly separated from each other in a direction of the flow of the air in the second sub-cavity 1112 by the influence of the pressure difference between the plurality of air outlets 116, and the air is not easily indirectly separated from each other due to the blocking and collision of the inner wall of the housing 11. The number of separation times of the air in the second sub-cavity 1112 is related to the number of the plurality of air outlets 116. In this way, the plurality of air outlets 116 have approximately equal air quantity, which may improve the user experience.

With reference to FIG. 7, the heating member 122 is also arranged between the first air outlet 1161 and the second air outlet 1162, and the air in the second sub-cavity 1112 flows toward the first air outlet 1161 and the second air outlet 1162 and passes through the heating member 122. On one hand, the heating member 122 located in the second sub-cavity 1112 may be in sufficient contact with the air. On the other hand, the heat of the surface of the heating member 122 located in the second sub-cavity 1112 may be taken away by the flow of the air, which may reduce the heat accumulation of the heating member 122 located in the second sub-cavity 1112.

In some embodiments, with reference to FIG. 3, the housing 11 includes an upper housing 117 and a lower housing 118, and the plurality of air outlets 116 are arranged on the lower housing 118. The upper housing 117 and the lower housing 118 jointly form the air cavity 111 and the air inlet part 115, which may reduce the processing and molding difficulty of the air cavity 111 and the air inlet part 115. Compared with an embodiment in which the upper housing 117 and the lower housing 118 jointly form the plurality of air outlets 116, the embodiment of the disclosure in which the plurality of air outlets 116 are located in the lower housing 118 allows each of the plurality of air outlets 116 to have a complete wall surface. In this way, the air discharged from the plurality of air outlets 116 is directly blown to the user, the air is not easy to be leaked from the plurality of air outlets 116, and the user may obtain greater air quantity.

In some embodiments, with reference to FIG. 3 and FIG. 5, the air blower 10 further includes a fan cover 14, and the fan cover 14 is arranged at the air inlet end 1151 of the air inlet part 115. The air inlet area 112 is in communication with the external environment (a mounting cavity 21) in a radial direction by the fan cover 14, and the air inlet area 112 is separated from the external environment (the mounting cavity 21) in an axial direction by the fan cover 14, to allow the air to only pass through the air inlet area 112 in the radial direction of the fan cover 14. In this way, an air inlet direction of the air inlet area 112 is changed, and the air enters the air inlet area 112 in a substantially “L” shape, which may reduce the noise generated in the flow process of the air. The fan cover 14 in the embodiment of the disclosure changes a path through which the air flows into the air inlet area 112, and reduces the noise generated in the air blower 10 without affecting the normal inlet air of the air inlet area 112.

The “axial direction of the fan cover 14” described above is a direction in which a central axis of the fan cover 14 is located, that is, the second direction N2 in FIG. 3. The “radial direction of the fan cover 14” described above is a direction extending perpendicular to the central axis, that is, a direction extending perpendicular to the second direction N2.

With reference to FIG. 1 and FIG. 2, an embodiment of the disclosure also provides a vertical hair dryer, which includes a fan head 101 and a support 102. The fan head 101 is connected to the support 102, and the support 102 is supported on the ground to allow two hands of the user to be freed. The fan head 101 includes the air blower 10 described above, which may prolong the service life of the vertical hair dryer and may reduce the heat accumulation of the vertical hair dryer.

In some possible embodiments, the fan head 101 is movably connected to the support 102, to allow an air outlet angle of the air blower 10 to be changed, and/or to allow the air blower 10 to move as a whole with the fan head 101 to allow the air to be discharged from the air blower 10 close to or away from the support 102. For example, the fan head 101 may be hinged to the support 102 through a universal ball joint. When the fan head 101 is driven to rotate counterclockwise as shown in FIG. 1, the air blower 10 is driven by the fan head 101 to allow the air to be discharged from the air blower 10 away from the support 102. When the fan head 101 is driven to rotate clockwise as shown in FIG. 1, the air blower 10 is driven by the fan head 101 to allow the air to be discharged from the air blower 10 close to the support 102. In this state, as shown in FIG. 1, the fan head 101 is adjacent to a side of the support 102. It can be understood that the fan head 101 is in a folded storage state in a viewing angle of FIG. 1, to save a storage space required by the vertical hair dryer in the disclosure. Certainly, the fan head 101 may be rotated along a front-rear direction as shown in FIG. 1. In this way, the fan head 101 is compatible with the posture of the user, to allow the air to be discharged from the fan head 101.

It can be understood that the expression “the fan head 101 is hinged to the support 102 through a universal ball joint” only serves as one embodiment. In some possible embodiments, the fan head 101 may also be translated relative to the support 102 by a telescopic arm. However, no matter what structure by which the fan head 101 is movably connected to the support 102, the fan head 101 may move relative to the support 102, to allow the air outlet angle of the air blower 10 to be changed, and/or to allow the air to be discharged from the air blower 10 close to or away from the support 102. In this way, the vertical hair dryer in the disclosure may be compatible with heights of the different users, to allow the air to be discharged from the vertical hair dryer, and the vertical hair dryer in the disclosure may be compatible with different locations (such as the top of the head and the rear of the head) of the same user, to allow the air to be discharged from the vertical hair dryer. Therefore, the user experience is better.

In some possible embodiments, the support 102 may be provided with a lifting mechanism, to allow the fan head 101 to be raised or lowered by a certain height. In this way, the fan head 101 is compatible with the sitting or standing posture of the user or is compatible with the heights of the different users. The lifting mechanism may be a structural control mechanism, for example, the external force of the user is received by a screw structure, and the user screws the screw structure to allow the fan head 101 to be raised or lowered. The lifting mechanism may also be an electrical induction control mechanism, for example, at least one of a visual sensing system or a height sensing system may be arranged on the support 102, and at least one of the visual sensing system or the height sensing system is configured to sense the height of the head of the user to allow the support 102 to be raised or lowered to a corresponding height. In this way, the human-computer interaction is automatically realized, and the user experience is improved.

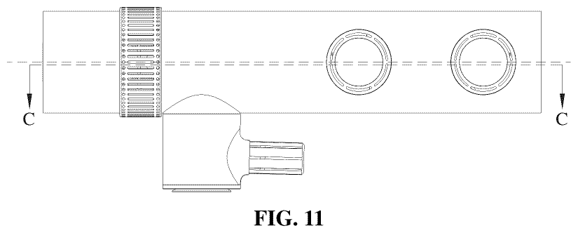

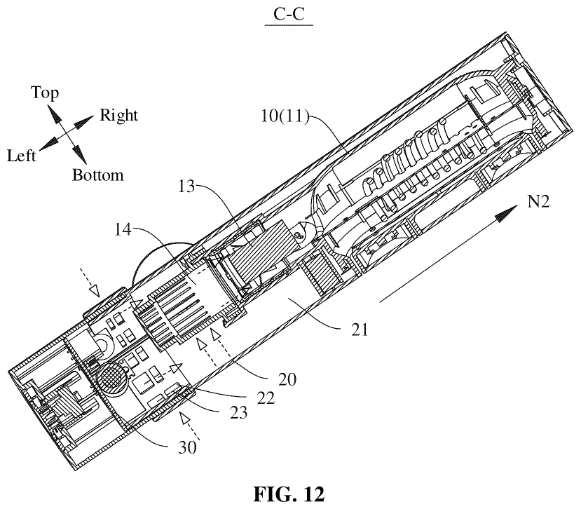

With reference to FIG. 11 and FIG. 12, the vertical hair dryer further includes a shell 20 and a circuit board 30. A mounting cavity 21 is formed inside the shell 20, the air blower 10 is arranged in the mounting cavity 21, and the mounting cavity 21 is in communication with the air cavity 111. In the disclosure, the shell 20 arranged outside the housing 11 is provided. On the one hand, the aesthetic appearance of the fan head 101 may be improved, and on the other hand, the heat of the air blower 10 may be isolated by a spacing between the shell 20 and the housing 11. The circuit board 30 is arranged in the mounting cavity 21. The circuit board 30 is configured to control an air outlet state of the air blower 10, which includes, but is not limited to, the fact that the circuit board 30 is configured to control the start and stop of the air blower 10, control the air outlet quantity of the air blower 10, and control the air outlet temperature of the air blower 10. The circuit board 30 is arranged in the mounting cavity 21 rather than being arranged in the air blower 10, to allow the circuit board 30 to work in the cold air and to allow the circuit board 30 to be not easily disturbed by the hot air of the air blower 10. In this way, the service life of the circuit board 30 is prolonged, the stability of the circuit connection is maintained, the service life of the vertical hair dryer is prolonged, and the use safety of the vertical hair dryer is improved.

In some embodiments, with reference to FIG. 12, the shell 20 is provided with an outer air outlet 22 in communication with the mounting cavity 21, and the outer air outlet 22 is arranged adjacent to the air inlet area 112 of the air blower 10. Specifically, with reference to the schematic diagram of the flow of the air in FIG. 12, the circuit board 30 is located on a side of the outer air outlet 22 away from the air blower 10. In some embodiments shown in FIG. 12, the air blower 10 is located on a right side of the outer air outlet 22, and the circuit board 30 is located on a left side of the outer air outlet 22. Since the circuit board 30 is not located between the outer air outlet 22 and the air blower 10, the circuit board 30 does not interfere with and block an inlet air of the outer air outlet 22. Since the circuit board 30 is arranged away from the air blower 10, the circuit board 30 is more easily in contact with the cold air, to exchange the heat with the cold air located at the outer air outlet 22. In this way, the heat dissipation of the circuit board 30 is facilitated, and the heat accumulation of a surface of the circuit board 30 is reduced.

In some embodiments, with reference to FIG. 2 and FIG. 12, the shell 20 further includes a plurality of ventilation meshes 23 nested with each other. A plurality of air outlets of the plurality of ventilation meshes 23 are misaligned with each other to allow a flow path of the air entering the mounting cavity 21 to be changed. In this way, a large noise generated by the air entering the mounting cavity 21 along a straight line is reduced, and the use comfort is improved.

What described above are merely preferable embodiments of the disclosure, and are not intended to limit the disclosure. Any modification, equivalent replacement, improvement and the like made within the spirit and principles of the disclosure should be included within the scope of protection of the disclosure.

1. An air blower, comprising:
a housing, wherein an air cavity, an air inlet area and an air outlet area are formed inside the housing, the air inlet area and the air outlet area are in communication with the air cavity, the air inlet area is configured to guide air into the air cavity, and the air outlet area is configured to discharge the air from the air cavity; and
a heating component configured to heat the air, wherein the heating component is arranged in the air cavity, the heating component separates the air cavity into a first sub-cavity and a second sub-cavity, the first sub-cavity is in communication with the air inlet area, the second sub-cavity is in communication with the air outlet area, wherein at least one of the heating component or the housing is provided with a ventilation area, and the ventilation area is in communication with the first sub-cavity and the second sub-cavity.

2. The air blower according to claim 1, wherein a volume of the first sub-cavity is greater than a volume of the second sub-cavity.

3. The air blower according to claim 1, wherein the air outlet area is arranged at an end of the heating component in a first direction, and the air inlet area is arranged at an end of the heating component in a second direction, wherein the first direction is perpendicular to the second direction.

4. The air blower according to claim 3, wherein the heating component comprises:
a first mounting plate extending along the second direction, wherein the first mounting plate is arranged in the housing, the first mounting plate separates the air cavity into the first sub-cavity and the second sub-cavity, wherein at least one of the first mounting plate or the housing is provided with a ventilation structure forming the ventilation area; and
a heating member configured to heat the air, wherein the heating member is arranged on the first mounting plate, and the heating member is arranged in at least one of the first sub-cavity or the second sub-cavity.

5. The air blower according to claim 4, wherein the heating member winds around the first mounting plate along the first direction; or
the heating member winds around the first mounting plate along the second direction; or
the third direction is perpendicular to the first direction and the second direction.

6. The air blower according to claim 5, wherein a volume of the heating member located in the first sub-cavity is greater than a volume of the heating member located in the second sub-cavity.

7. The air blower according to claim 5, wherein the heating component further comprises:
a second mounting plate connected to the first mounting plate, wherein the second mounting plate abuts against the heating member along the first direction.

8. The air blower according to claim 1, wherein the housing is provided with an air inlet part, the air inlet part is hollow, the air inlet part is provided with an air inlet end and an air outlet end, the air inlet area is formed between the air inlet end and the air outlet end, and the air outlet end is connected to the air cavity;
wherein the air blower further comprises a fan arranged between the air inlet end and the air outlet end.

9. The air blower according to claim 1, wherein the housing is provided with a plurality of air outlets on a side of the housing, and the plurality of air outlets form the air outlet area.

10. The air blower according to claim 9, wherein the plurality of air outlets comprise a first air outlet and a second air outlet, and at least a part of the ventilation area is arranged between the first air outlet and the second air outlet.

11. A vertical hair dryer, comprising:
a support; and
a fan head connected to the support, wherein the fan head comprises an air blower, the air blower comprising:
a housing, wherein an air cavity, an air inlet area and an air outlet area are formed inside the housing, the air inlet area and the air outlet area are in communication with the air cavity, the air inlet area is configured to guide air into the air cavity, and the air outlet area is configured to discharge the air from the air cavity; and
a heating component configured to heat the air, wherein the heating component is arranged in the air cavity, the heating component separates the air cavity into a first sub-cavity and a second sub-cavity, the first sub-cavity is in communication with the air inlet area, the second sub-cavity is in communication with the air outlet area, wherein at least one of the heating component or the housing is provided with a ventilation area, and the ventilation area is in communication with the first sub-cavity and the second sub-cavity.

12. The vertical hair dryer according to claim 11, wherein the fan head further comprises:
a shell connected to the support, wherein a mounting cavity is formed inside the shell, the air blower is arranged in the mounting cavity, and the mounting cavity is in communication with the air cavity; and
a circuit board arranged in the mounting cavity, wherein the circuit board is configured to control an air outlet state of the air blower.

13. The vertical hair dryer according to claim 11, wherein a volume of the first sub-cavity is greater than a volume of the second sub-cavity.

14. The vertical hair dryer according to claim 11, wherein the air outlet area is arranged at an end of the heating component in a first direction, and the air inlet area is arranged at an end of the heating component in a second direction, wherein the first direction is perpendicular to the second direction.

15. The vertical hair dryer according to claim 14, wherein the heating component comprises:
a first mounting plate extending along the second direction, wherein the first mounting plate is arranged in the housing, the first mounting plate separates the air cavity into the first sub-cavity and the second sub-cavity, wherein at least one of the first mounting plate or the housing is provided with a ventilation structure forming the ventilation area; and
a heating member configured to heat the air, wherein the heating member is arranged on the first mounting plate, and the heating member is arranged in at least one of the first sub-cavity or the second sub-cavity.

16. The vertical hair dryer according to claim 15, wherein the heating member winds around the first mounting plate along the first direction; or
the heating member winds around the first mounting plate along the second direction; or
the third direction is perpendicular to the first direction and the second direction.

17. The vertical hair dryer according to claim 16, wherein a volume of the heating member located in the first sub-cavity is greater than a volume of the heating member located in the second sub-cavity.

18. The vertical hair dryer according to claim 16, wherein the heating component further comprises:
a second mounting plate connected to the first mounting plate, wherein the second mounting plate abuts against the heating member along the first direction.

19. The vertical hair dryer according to claim 11, wherein the housing is provided with an air inlet part, the air inlet part is hollow, the air inlet part is provided with an air inlet end and an air outlet end, the air inlet area is formed between the air inlet end and the air outlet end, and the air outlet end is connected to the air cavity;
wherein the air blower further comprises a fan arranged between the air inlet end and the air outlet end.

20. The vertical hair dryer according to claim 11, wherein the housing is provided with a plurality of air outlets on a side of the housing, and the plurality of air outlets form the air outlet area.
